(19) United States
(12) Patent Application Publication
(10) Pub. No.: US 2024/0265446 A1
(43) Pub. Date: Aug. 8, 2024

(54) COMPUTER-IMPLEMENTED SYSTEM AND METHOD FOR BLOCKCHAIN-ENABLED DOCUMENTATION OF TRADE TRANSACTIONS

(71) Applicant: Azam Pasha, Dubai (AE)

(72) Inventors: Azam Pasha, Dubai (AE); Rohit Majhi, Pune (IN)

(21) Appl. No.: 18/430,121

(22) Filed: Feb. 1, 2024

Related U.S. Application Data
(60) Provisional application No. 63/442,941, filed on Feb. 2, 2023.

(51) Int. Cl. G06Q 40/04; G06Q 20/38; G06Q 30/018; G06Q 50/02

(52) U.S. Cl. CPC G06Q 40/04; G06Q 20/38215; G06Q 20/389; G06Q 30/0185; G06Q 50/02

(57) ABSTRACT

Embodiments of the present invention provide a system for blockchain-enabled documentation of trade transactions. The system includes buyer and seller devices for transaction execution, a processor, and a memory unit storing instructions. The system receives transaction documents from these devices, compiles them for each trade, and watermarks them with a Unique Acceptance Code (UAC). It generates a unique hash, either an Inspection Report Code (IRC) or a Commercial Invoice Code (CIC), for each document, acting as a distinct identifier. These hashes, alongside event types and timestamps, are recorded on the blockchain to ensure transaction data's immutability and transparency. Additionally, the system generates a blockchain certificate for each recorded event, confirming transaction completion and authenticity. This setup leverages the blockchain's inherent properties to provide a secure, verifiable record-keeping system for agricultural trade documents.

### CROSS REFERENCE TO RELATED APPLICATION

The present application is a non-provisional application based on, and claims priority from U.S. patent application Ser. No. 63/442,941, filed on Feb. 2, 2023.

### TECHNICAL FIELD

The present invention relates generally to the field of digital transaction technologies and, more specifically, to a computer-implemented system and method for blockchain-enabled documentation of trade transactions.

### BACKGROUND OF THE INVENTION

The subject matter discussed in the background section should not be assumed to be prior art merely as a result of it being mentioned in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Traditional agricultural trade transactions often involve extensive paper-based documentation and manual processing, including the generation, signing, and exchange of various documents such as inspection reports, delivery orders, and commercial invoices. This conventional process suffers from several drawbacks:

Vulnerability to Fraud and Errors: Manual handling and paper-based documentation are prone to human errors and fraudulent activities, such as document forgery and unauthorized alterations.

Lack of Transparency: Traditional methods often lack adequate transparency, making it challenging for parties to track the status and authenticity of transactions, leading to disputes and trust issues.

Inefficiencies in Processing: Manual processes are time-consuming and labor-intensive, leading to delays in transaction completion and increased operational costs.

Difficulty in Compliance and Verification: Ensuring compliance with international trade laws and standards is cumbersome, and verifying the authenticity of documents across different jurisdictions adds complexity.

Limited Accessibility and Scalability: Small-scale traders and businesses often find it difficult to access and manage traditional trade systems efficiently, limiting their ability to participate in global markets.

Recent advancements in digital technology have led to the development of electronic and online systems to manage trade transactions. However, these systems still face issues with security, data integrity, and universal acceptance. Blockchain technology has emerged as a potential solution to these problems, offering advantages such as immutability, transparency, and secure record-keeping. However, existing blockchain-based solutions have not fully addressed the specific needs and challenges of agricultural trade transactions, particularly in integrating the diverse aspects of these transactions into a cohesive and user-friendly system.

The present invention seeks to address these drawbacks by providing a comprehensive, blockchain-based solution tailored for the agricultural trade sector. The invention aims to enhance the security, efficiency, and transparency of agricultural trade transactions while ensuring compliance with international standards and facilitating easier participation for small and medium-sized enterprises in the global market.

### SUMMARY OF THE INVENTION

According to a first aspect of the present invention, there is provided a computer-implemented system for blockchain-enabled documentation of trade transactions. The system comprises one or more buyer devices associated with respective buyers performing agricultural trade transactions; one or more seller devices, associated with respective sellers performing agricultural trade transactions; a processor; and a memory unit configured to store machine readable instructions that, when executed by the processor, cause the computer system to receive, transaction documents from the one or more buyer devices and the one or more seller devices; compile a set of transaction documents for each agricultural trade transaction, wherein a transaction from the buyer device is in relation to an event type selected from acceptance of goods or payment by the buyer; watermark each of the compiled documents with a Unique Acceptance Code (UAC); generate a unique hash for each document watermarked with the UAC, wherein the hash is either an Inspection Report Code (IRC) or a Commercial Invoice Code (CIC) corresponding to the acceptance of goods or payment by the buyer respectively, which serves as a novel identifier for the said document; record the generated IRC or CIC onto the blockchain platform, along with the event type and document timestamp, to ensure the immutability and transparency of the transaction data; generate a blockchain certificate for each event recorded on the blockchain platform; and utilize the blockchain platform to provide a verifiable and permanent record-keeping system, wherein the immutability of records is achieved through the blockchain's inherent properties, thereby enhancing the security and authenticity of the agricultural trade documents.

In accordance with an embodiment of the present invention, the set of transaction documents comprising at least an inspection report received from the seller device, confirming the condition of goods supplied by a seller; and a signed delivery order or commercial invoice from the one or more buyer devices, each related to the event type selected from the acceptance of goods or payment by the buyer, respectively.

In accordance with an embodiment of the present invention, the UAC includes at least one of a Deal Transaction Number uniquely identifying the trade transaction; a Document Sequence and Type indicating the sequential order and category of the document within the transaction; and a GMT Timestamp marking the exact date and time of document issuance.

In accordance with an embodiment of the present invention, the unique hash is designated as the Inspection Report Code (IRC) for documents corresponding to the acceptance of goods; or the Commercial Invoice Code (CIC) for documents corresponding to the acceptance of payment by the buyer; each hash serving as a novel identifier for the said document.

In accordance with an embodiment of the present invention, each certificate signifies the blockchain's confirmation of the acceptance of goods or payment as per the respective IRC or CIC; and confirms the completion and immutability of the respective transactions within the agricultural trade process.

In accordance with an embodiment of the present invention, the blockchain platform is a Polygon blockchain.

In accordance with an embodiment of the present invention, the one or more buyer devices further comprise a user interface configured to allow buyers to manually verify and sign the delivery order or commercial invoice digitally within the device before providing it to the system.

In accordance with an embodiment of the present invention, the one or more seller devices include an imaging component configured to capture visual confirmation of the goods for inclusion in the inspection report, and which integrates with the system to facilitate automatic watermarking with the UAC.

In accordance with an embodiment of the present invention, the system further comprises a cryptographic module managed by the processor that encrypts the unique hash for each document to enhance security before recording on the blockchain platform.

In accordance with an embodiment of the present invention, the processor is further configured to verify the legal form and competence of the parties to the contract based on the respective local jurisdictions before generating the IRC or CIC, ensuring that each digital smart contract is compliant with applicable international trade laws.

In accordance with an embodiment of the present invention, the memory unit contains additional machine-readable instructions that, when executed by the processor, enable the system to automatically match buyers with sellers based on the availability of goods and requirements, thereby facilitating the formation of digital contracts within the agricultural trade process.

According to a second aspect of the present invention, there is provided a computer-implemented method for blockchain-enabled documentation of trade transactions. The method comprises steps of receiving, transaction documents from one or more buyers and one or more sellers; compiling a set of transaction documents for each agricultural trade transaction, wherein a transaction from the buyer device is in relation to an event type selected from acceptance of goods or payment by the buyer; watermarking each of the compiled documents with a Unique Acceptance Code (UAC); generating a unique hash for each document watermarked with the UAC, wherein the hash is either an Inspection Report Code (IRC) or a Commercial Invoice Code (CIC) corresponding to the acceptance of goods or payment by the buyer respectively, which serves as a novel identifier for the said document; recording the generated IRC or CIC onto the blockchain, along with the event type and document timestamp, to ensure the immutability and transparency of the transaction data; generating a blockchain certificate for each event recorded on the blockchain platform; utilizing the blockchain platform to provide a verifiable and permanent record-keeping system, wherein the immutability of records is achieved through the blockchain's inherent properties, thereby enhancing the security and authenticity of the agricultural trade documents.

In accordance with an embodiment of the present invention, the set of documents comprises at least an inspection report confirming the condition of goods supplied by a seller; and a signed delivery order or commercial invoice, each related to the acceptance of goods or payment by a buyer, respectively.

In accordance with an embodiment of the present invention, the UAC includes a Deal Transaction Number uniquely identifying the trade transaction; a Document Sequence and Type indicating the sequential order and category of the document within the transaction; and a GMT Timestamp marking the exact date and time of document issuance.

In accordance with an embodiment of the present invention, the unique hash is designated as an Inspection Report Code (IRC) for documents corresponding to the acceptance of goods; or a Commercial Invoice Code (CIC) for documents corresponding to the acceptance of payment by the buyer; each hash serving as a novel identifier for the said document.

In accordance with an embodiment of the present invention, each certificate signifies the blockchain's confirmation of the acceptance of goods or payment as per the respective IRC or CIC; and confirms the completion and immutability of the respective transactions within the agricultural trade process.

In accordance with an embodiment of the present invention, the method further comprises step of allowing buyers to manually verify and sign the delivery order or commercial invoice digitally within the device before providing it to the system.

In accordance with an embodiment of the present invention, the method further comprises step of capturing visual confirmation of the goods for inclusion in the inspection report, and which integrates with the system to facilitate automatic watermarking with the UAC.

In accordance with an embodiment of the present invention, the method further comprises step of encrypting the unique hash for each document to enhance security before recording on the blockchain platform.

In accordance with an embodiment of the present invention, the method further comprises step of verifying the legal form and competence of the parties to the contract based on the respective local jurisdictions before generating the IRC or CIC, ensuring that each digital smart contract is compliant with applicable international trade laws.

In accordance with an embodiment of the present invention, the method further comprises step of enable the system to automatically match buyers with sellers based on the availability of goods and requirements, thereby facilitating the formation of digital contracts within the agricultural trade process.

In accordance with an embodiment of the present invention, the blockchain is a Polygon blockchain.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates a computer-implemented system for blockchain-enabled documentation of trade transactions, in accordance with an embodiment of the present invention;

FIG. 2 illustrates method for blockchain-enabled documentation of trade transactions, in accordance with an embodiment of the present invention; and

FIGS. 3A-3B illustrate information flow diagrams showcasing an exemplary implementation of the system and method of FIGS. 1 and 2, in accordance with an embodiment of the present invention.

### DETAILED DESCRIPTION OF THE DRAWINGS

While the present invention is described herein by way of example using embodiments and illustrative drawings, those skilled in the art will recognize that the invention is not limited to the embodiments of drawing or drawings described and is not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed. Still, on the contrary, the invention is to cover all modifications, equivalents, and alternatives falling within the scope of the present invention as defined by the appended claims. As used throughout this description, the word “may” is used in a permissive sense (i.e., meaning having the potential to), rather than the mandatory sense, (i.e., meaning must). Further, the words “a” or “an” mean “at least one” and the word “plurality” means “one or more” unless otherwise mentioned. Furthermore, the terminology and phraseology used herein are solely used for descriptive purposes and should not be construed as limiting in scope. Language such as “including,” “comprising,” “having,” “containing,” or “involving,” and variations thereof, is intended to be broad and encompass the subject matter listed after that, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles, and the like is included in the specification solely to provide a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element, or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims.

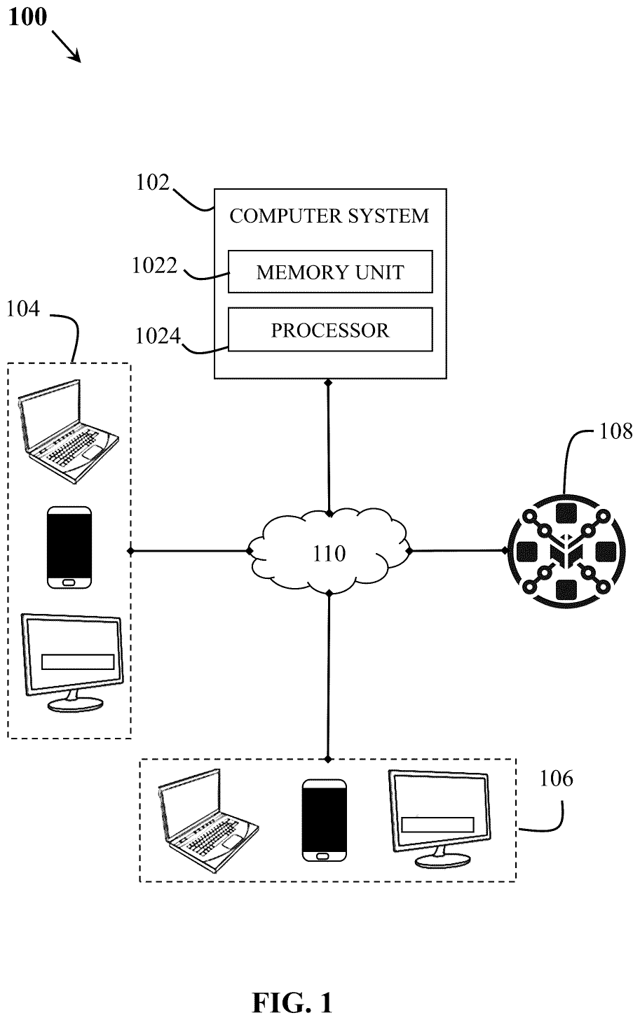

Referring to the drawings, the invention will now be described in more detail. FIG. 1 1 illustrates a computer-implemented system for blockchain-enabled documentation of trade transactions, in accordance with an embodiment of the present invention. As shown in FIG. 1, the system 100 comprises, but not limited to, one or more buyer devices 104 associated with respective buyers; one or more seller devices 106 associated with respective sellers; a blockchain platform 108; and a computer system 102 connected with the one or more buyer devices 104, the one or more seller devices 106, the and the blockchain platform 108, via a communication network 110.

Returning to FIG. 1, The depicted embodiment includes various hardware components that are integral to the system 100 operation, each with distinct capabilities and connections to other components within the system 100. Each component will now be discussed in detail below:

As can be seen from the FIG. 1, the brain of the system 100 is the computer system 102. In that sense, the computer system 102 may be envisioned as the central processing unit of the system 100. It comprises a processor 1024 and a memory unit 1022. The processor 1024 is a critical component that executes machine-readable instructions stored within the memory unit 1022. The processor 1024 may be one of, but not limited to, a general-purpose processor 1024, an application-specific integrated circuit (ASIC), or a field-programmable gate array (FPGA).

The memory unit 1022 of the computer system 102 is configured to store machine-readable instructions that, when executed by the processor 1024, enable the computer system 102 to perform a multitude of functions relevant for blockchain-enabled documentation of trade transactions and/or automating the generation and execution of digital smart contracts. The memory unit 1022 can be selected from a group comprising, but not limited to, Electrically Programmable Read-Only Memory (EPROM), Electrically Erasable Programmable Read-Only Memory (EEPROM), and Flash memory. The memory unit 1022 can be loaded with machine-readable instructions from a non-transitory machine-readable medium, such as, but not limited to, CD-ROMs, DVD-ROMs, and Flash Drives. Alternatively, the machine-readable instructions can be loaded in the form of a computer software program into the memory unit 1022.

The computer system 102 may also include a communication module (not shown) specifically designed to enable wireless connections with the one or more buyer devices 104, and the one or more seller devices 106 over the communication network 110. The communication module is pivotal in facilitating seamless wireless communication within the system 100, ensuring that data transfer and interactions between these components are efficient and secure. The wireless capabilities of the communication module extend to its integration with the one or more buyer devices 104, the one or more seller devices 106, and the blockchain platform 108, essential for the real-time data processing and secure data handling required by the system 100. The module supports various wireless communication protocols, such as Wi-Fi, Bluetooth, and NFC (Near Field Communication), allowing for flexible and robust connectivity options. These protocols enable the computer system 102 to maintain continuous and reliable wireless connections, which are vital for the dynamic updating and real-time data processing functionalities of the system 100.

In that sense, the communication network 110 can be a short-range communication network 110 and/or a long-range communication network 110. The communication interface includes, but is not limited to, a serial communication interface, a parallel communication interface, or a combination thereof. The communication network 110 enables the seamless transfer of data and instructions between the components of the system 100. It may utilize various communication protocols and technologies, including, but not limited to, the Internet, intranets, virtual private networks (VPNs), and cloud-based services, ensuring that the system 100 remains connected and responsive to the needs of the users.

FIG. 1 also illustrates the blockchain platform 108 associated with the computer system 102. This invention employs a blockchain platform 108 as a fundamental component of the system 100 for automating the generation and execution of digital smart contracts in agricultural trade transactions. The blockchain platform 108 is selected for its inherent properties, which address several limitations of traditional and prior art transaction systems. Once transaction data, is recorded on the blockchain, it cannot be altered. This immutability ensures the integrity and trustworthiness of the transaction records, safeguarding against fraudulent activities and unauthorized modifications. All transaction records on the blockchain are transparent and accessible to authorized participants. This transparency facilitates easy tracking and verification of transaction stages, enhancing trust among all stakeholders involved in the agricultural trade.

The blockchain platform 108 employs advanced cryptographic techniques to secure data, ensuring that transaction records and digital smart contracts are protected from unauthorized access and breaches. Unlike traditional centralized systems, the blockchain operates on a decentralized network, distributing the transaction data across multiple nodes. This decentralization enhances the system's 100 resilience against single points of failure and potential data manipulation. The blockchain platform 108 is designed for high performance, enabling quick processing and recording of transactions. This efficiency is crucial in fast-paced trade environments where timely execution of contracts and verification of documents are essential. The platform supports the creation and execution of digital smart contracts, automating various aspects of agricultural trade transactions, such as contract formation, compliance checks, and execution of terms.

Recognizing the diverse nature of global agricultural trade, the blockchain platform 108 is built with interoperability in mind, allowing seamless integration with various external systems and technologies. The platform can be customized to suit the specific requirements of different agricultural trade transactions, accommodating various types of commodities, trade laws, and business practices. The blockchain platform 108 includes user-friendly interfaces for both buyers and sellers, simplifying interactions with the system 100 and ensuring ease of use even for participants with limited technical expertise. The platform is designed to comply with international trade laws and standards, ensuring that transactions executed through the system 100 are legally sound and globally accepted.

Additionally, the one or more buyer devices 104 and the one or more seller devices 106 as shown in FIG. 1, play a pivotal role in the present invention. These devices may encompass a range of computing devices, including, but not limited to, desktop PCs, laptops, PDAs, and handheld computing devices such as smartphones and tablets. Each device is equipped with microprocessors that facilitate processing and communication capabilities, enabling them to interface seamlessly with the computer system 102 through both wired and wireless connections. In certain embodiments of the invention, these buyer devices 104 and seller devices 106 are more than mere conduits for data input and output; they may themselves house the processor 1024 along with their inherent functionalities. This embodiment allows for a versatile application of the invention, where the processing power is not confined to a central computer system 102 but distributed across various buyer devices 104 and seller devices 106.

In accordance with an embodiment of the present invention, the one or more buyer devices 104 and the one or more seller devices 106 are registered with the system 100, which is crucial for ensuring secure and personalized user interaction. During the registration process, the one or more buyer devices 104 and one or more seller devices 106 capture and submit essential details to the computer system 102. This information can range from basic identification data, such as usernames and contact numbers, to more specific details like areas of interest, business information, and product specifications. In order to enhance the security and integrity of the system 100, the registration process may also incorporate biometric authentication methods. These methods could include, but are not limited to, fingerprint recognition, face recognition, and iris recognition, ensuring that access to the system 100 is restricted to authorized users only.

This approach of integrating the registration and data management functionalities directly into the buyer devices 104 and seller devices 106 offers several advantages. It streamlines the user experience by allowing for immediate and secure registration and authentication, which is essential in a system handling sensitive contractual and operational data. Furthermore, by decentralizing these functions, the system 100 enhances its resilience and efficiency, as each device becomes a self-sufficient node capable of managing its own security and data interactions with the computer system 102.

In accordance with an additional or alternative embodiment of the present invention, the computer system 102 may be configured in a remotely distributed system. This embodiment contemplates various arrangements for processing and data handling. For instance, the processing tasks traditionally assigned to the central computer system 102 could be performed on a remote server, effectively leveraging cloud computing technologies. This arrangement offers the flexibility of scalable computing resources and enables efficient handling of large data sets, which is particularly beneficial for the complex algorithms of the present invention.

Alternatively, the processing could be decentralized and carried out on the processors within the one or more buyer devices 104 or seller devices 106. This distributed processing approach allows for a more resilient system architecture, reducing reliance on a single processing point and potentially enhancing the speed and responsiveness of the blockchain-enabled documentation process.

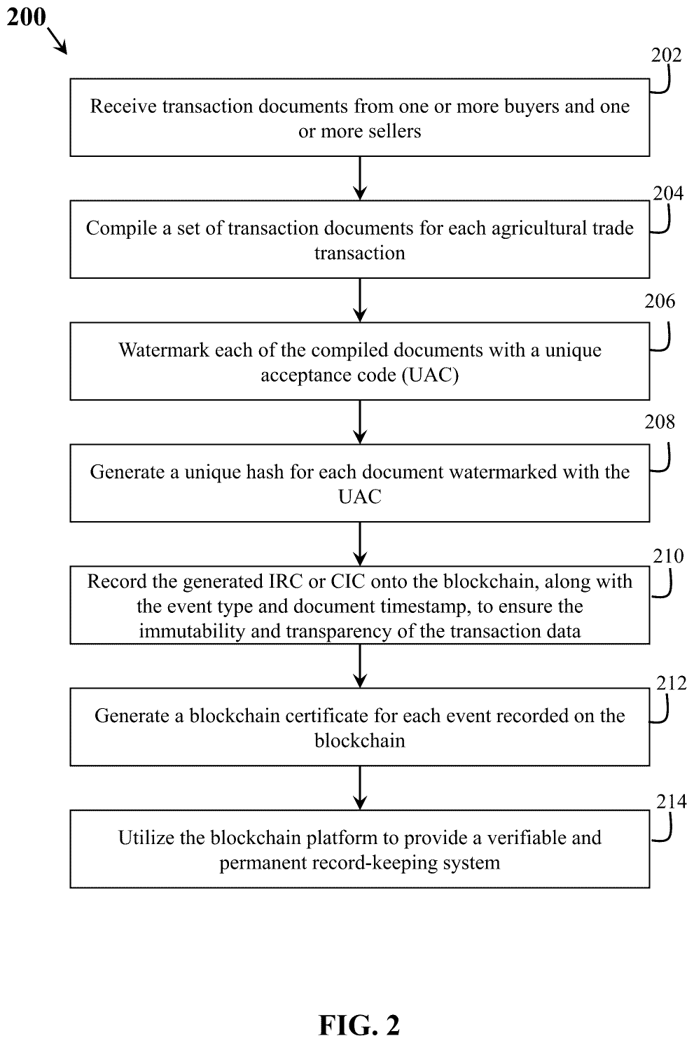

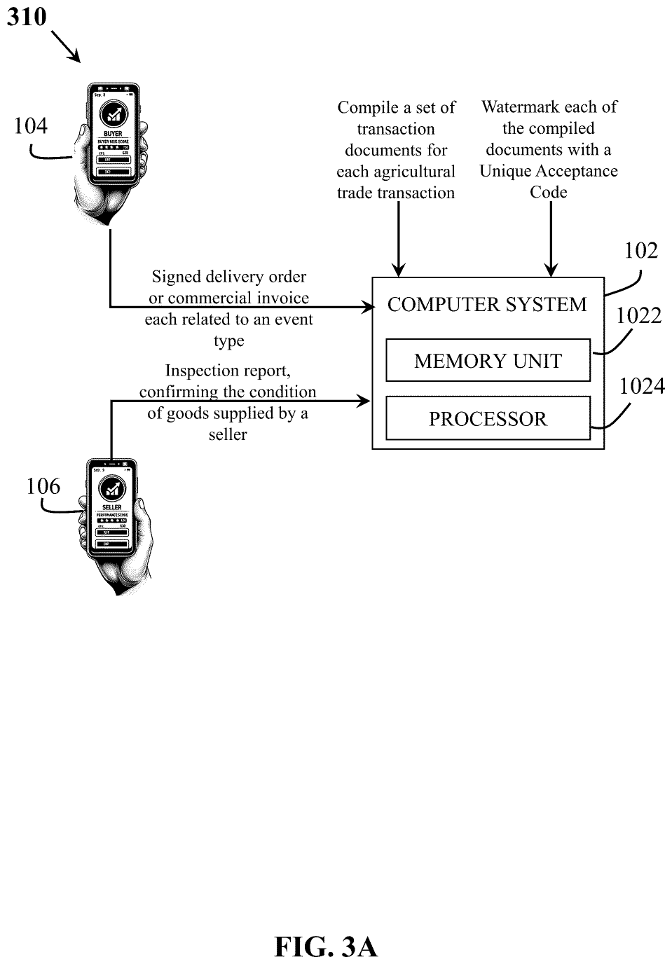

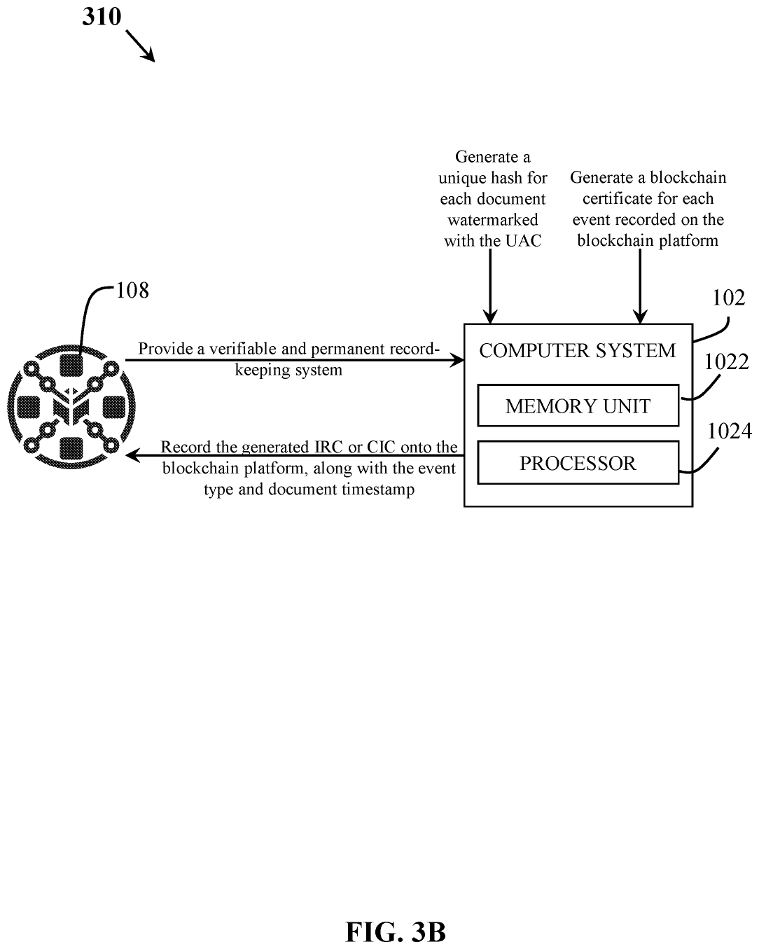

FIG. 2 illustrates method 200 for blockchain-enabled documentation of trade transactions, in accordance with an embodiment of the present invention. However, the computer-implemented method 200 would be better understood in reference of FIG. 3A-3B, side by side. FIG. 3A-3B illustrate information flow diagrams showcasing an exemplary implementation of the system 100 and method of FIGS. 1 and 2, in accordance with an embodiment of the present invention. This will provide a clearer understanding of the operational intricacies and the innovative aspects of the present invention.

So, the computer implemented as shown in FIG. 2, includes:

Step 202 (receive transaction documents from one or more buyers and one or more sellers): The computer-implemented method 200 begins at step 202 (also depicted in FIG. 3A), where the computer system 102 first receives transaction documents from buyer and seller devices 106. The buyer devices 104 are used by buyers to provide signed delivery orders or commercial invoices. Further, the buyer may provide their terms of a contract as the transaction documents. Similarly, seller devices 106 are used by sellers to provide inspection reports confirming the condition of the goods supplied. Furthermore, the seller may provide their terms of the contract as the transaction documents.

The computer system 102 is equipped with a network interface that allows it to communicate with various devices over a network. This could be an internet connection, a local network, or any other digital communication means. The buyer devices 104, which are associated with the buyers in the trade transactions, use this network connection to transmit signed delivery orders or commercial invoices to the computer system 102. These documents may be typically digitized versions of traditional paper documents and may bear the digital or electronic signatures of the buyers, which serve as a verification of the buyers' approval and commitment to the terms of the transactions.

The seller devices 106, which are associated with the sellers, send inspection reports to the computer system 102. These inspection reports contain details about the quality and condition of the agricultural goods that are being sold. The reports ensure that the goods meet the agreed standards and serve as a record of the product's state at the time of inspection. Upon receiving the documents, the computer system's 102 processor 1024 may use pre-programmed instructions, stored on a memory unit 1022, to verify the authenticity and completeness of the documents. This step is crucial to prevent fraud and ensure that only valid and complete transactions proceed.

Step 204 (compile a set of transaction documents for each agricultural trade transaction): At step 204, the computer-implemented method 200 involves compiling a set of transaction documents for each agricultural trade transaction. The transaction from the buyer device 104 is in relation to an event type selected from acceptance of goods or payment by the buyer. As illustrated in FIG. 3A, once the documents are received, the computer system's 102 processor 1024, which operates based on instructions stored in the memory unit 1022, compiles these documents for each agricultural trade transaction. The compilation involves organizing the documents in a structured manner that corresponds with the type of event they represent, either the acceptance of goods or payment. In a broader sense, digital acceptance of key contract events by a Buyer, like “Delivery” and “Payment,” is recorded using blockchain technology. When a Buyer electronically acknowledges receipt of goods or services (Delivery) or accepts payment-related documents, this acceptance is documented by generating a digital hash (a unique cryptographic representation) of these documents. These hashes are then stored on a blockchain. This method ensures a secure, tamper-proof record of each important contract event, providing transparency and trust in the transaction process. This blockchain-based approach significantly enhances the integrity and verification capabilities in contract management.

The buyer devices 104 send signed delivery orders or commercial invoices and the seller devices 106 provide inspection reports confirming the condition of the goods supplied. In accordance with an additional or alternative embodiment of the present invention, the one or more buyer devices 104 further comprise a user interface configured to allow buyers to manually verify and sign the delivery order or commercial invoice digitally within the device before providing it to the system 100.

These documents are crucial as they constitute the formal agreement between the buyers and sellers, detailing the terms of the trade, the condition of the goods, and the payment details. The processor 1024 of the computer system 102, operating under the guidance of machine-readable instructions stored in the memory unit 1022, begins to organize and compile these received documents. The compilation is not just an aggregation of documents; it involves structuring the documents in a way that aligns with the nature of the transaction events they represent. This means categorizing and indexing the documents based on whether they pertain to the acceptance of goods (e.g., inspection reports) or to the acceptance of payment (e.g., commercial invoices). After compilation, a digital contract document may be formed which may contain, but not limited to, Offer, Acceptance, Consideration, Mutual Assent or Meeting of the Minds, Capacity, Legality (dependent upon local jurisdictions of buyers and sellers), Intention to Create Legal Relations, Possibility of Performance, Formalities and Clarity of Terms.

Each transaction from the buyer device 104 is associated with a specific event type, such as the acceptance of goods or payment by the buyer. The system 100 categorizes and organizes the documents based on these event types, which is crucial for the later stages of processing, such as generating unique hashes and recording data onto the blockchain.

The step 204 is about systematically organizing the key transaction documents according to their relevance to different aspects of the trade transaction. This step is fundamental in ensuring that all subsequent processes in the method, like digital signing, watermarking, and blockchain recording, are accurately and efficiently executed.

Step 206 (watermark each of the compiled documents with a Unique Acceptance Code (UAC)): Proceeding to step 206, the computer-implemented method 200 utilizes processor 1024 to watermark each of the compiled documents with a Unique Acceptance Code (UAC). In accordance with an embodiment of the present invention, this step, as visualized in FIG. 3A, includes each compiled document is then watermarked with a Unique Acceptance Code (UAC). In accordance with an additional or alternative embodiment, the one or more seller devices 106 may include an imaging component configured to capture visual confirmation of the goods for inclusion in the inspection report, and which integrates with the system 100 to facilitate automatic watermarking with the UAC. The watermarking process embeds details such as the Deal Transaction Number, Document Sequence indicating the sequential order and category of the document within the transaction and Type, and a GMT.

In this step, the processor 1024 of the computer system 102 applies a Unique Acceptance Code (UAC) to each of the compiled transaction documents. This process is vital for adding an additional layer of security and uniqueness to each document. The UAC serves as a digital marker or tag for the document, embedding specific details that uniquely identify the document within the context of the agricultural trade transaction. Components of UAC:

Deal Transaction Number: This is a unique identifier assigned to each trade transaction. It differentiates one transaction from another and is crucial in a system where multiple transactions may be processed concurrently or over time.

Document Sequence and Type: This aspect of the UAC indicates the sequential order of the document within the transaction and its category. For instance, whether the document is the first, second, or subsequent in the series of transactions, and whether it is an invoice, delivery order, or inspection report.

GMT Timestamp: The UAC also includes a Greenwich Mean Time (GMT) timestamp, marking the exact date and time when the document was issued or signed. This timestamp is critical for maintaining an accurate and verifiable timeline of the transaction events.

The watermarking process, by embedding these unique identifiers into the documents, ensures that each document can be accurately traced and verified within the system 100. It also prevents tampering or unauthorized duplication of the documents, as the UAC would not match in cases of forgery or alteration. This step is a part of the system's 100 broader goal to automate and secure agricultural trade transactions. By marking each document with a UAC, the system 100 lays the groundwork for subsequent steps like generating unique hashes, recording data on the blockchain, and issuing blockchain certificates.

The step 206 is about embedding a unique digital signature (UAC) into each transaction document. This signature contains vital information about the transaction and the document itself, playing a key role in maintaining the integrity and traceability of the transaction within the agricultural trade process.

Step 208 (generate a unique hash for each document watermarked with the UAC): At step 208, the computer-implemented method 200 the processor 1024, as shown in FIG. 3B, is configured to generate a unique hash for each document watermarked with the UAC. The hash is either an Inspection Report Code (IRC) or a Commercial Invoice Code (CIC) corresponding to the acceptance of goods or payment by the buyer respectively, which serves as a novel identifier for the said document. For each watermarked document, the system 100 generates a unique hash. This hash could be an IRC or a CIC, depending on whether the document is related to the acceptance of goods or payment. The IRC for documents corresponding to the acceptance of goods. The CIC for documents corresponding to the acceptance of payment by the buyer. Each hash serving as a novel identifier for the said document.

For each document that has been watermarked with the UAC, the processor 1024 generates a unique hash. This hash functions as a digital fingerprint of the document, created through a cryptographic algorithm. The uniqueness of the hash ensures that even minor changes in the document will result in a completely different hash value, thereby facilitating the detection of any alterations or tampering.

The type of hash generated depends on the nature of the document. The IRC hash type is generated for documents related to the inspection of goods, such as quality reports or certificates that confirm the condition and compliance of the goods being traded. The IRC uniquely identifies these inspection-related documents. The CIC is generated for financial documents like commercial invoices or payment receipts which are associated with the payment process of the transaction, the system 100 generates the CIC. This hash type is specific to documents that confirm financial transactions between the buyer and seller.

Each hash (IRC or CIC) serves as a novel identifier for the respective document. It is used to securely and uniquely identify each document within the system 100. This feature is particularly important in the context of digital smart contracts and blockchain technology where document authenticity and non-repudiation are crucial. These unique hashes are integral to the process of recording the transaction on a blockchain platform 108. When the IRC or CIC is recorded on the blockchain, it ensures that the document's integrity is maintained. Any attempt to alter the document post-hash generation would be evident as the altered document would generate a different hash, which would not match the one recorded on the blockchain.

The step 208 is a critical stage in securing and authenticating the documents involved in agricultural trade transactions. By generating unique hashes for each watermarked document, the system 100 provides a robust means to maintain the integrity of the transactional records. This step ensures that each document can be reliably authenticated and traced throughout the transaction process, which is particularly vital in a digital and decentralized environment like a blockchain platform 108. The use of IRC and CIC as unique identifiers for different types of documents further enhances the specificity and reliability of the transaction records. In accordance with an additional or alternative embodiment of the present invention, the system 100 may further comprise a cryptographic module managed by the processor 1024 that encrypts the unique hash for each document to enhance security before recording on the blockchain platform 108.

Step 210 (record the generated IRC or CIC onto the blockchain): Then, Step 210 as shown in FIG. 3B, the processor 1024 is configured to record the generated IRC or CIC onto the blockchain platform 108, along with the event type and document timestamp, to ensure the immutability and transparency of the transaction data. The generated IRC or CIC is recorded onto the blockchain platform 108, along with the event type and document timestamp. This step ensures that the data is immutable and transparently stored on the blockchain, which is identified as a Polygon blockchain.

At Step 210 in the computer-implemented method, the processor 1024 plays a key role in integrating the blockchain technology into the system 100 for recording transaction data. This step ensures the immutability and transparency of the transaction data on the blockchain. After the unique hashes, either IRC (Inspection Report Code) or CIC (Commercial Invoice Code), are generated for each document, the processor 1024 records these hashes onto a blockchain platform 108. The IRC corresponds to documents related to the acceptance of goods, while the CIC is associated with documents related to the acceptance of payment by the buyer. Along with the IRC or CIC, the event type and the document timestamp are also recorded on the blockchain. The event type provides context about the nature of the transaction (whether it's related to goods or payment), and the timestamp ensures a chronological record of events.

Recording this information on the blockchain ensures that once entered, the data cannot be altered, thus providing immutability. This immutability is crucial in providing trust and reliability in the system 100, as all parties involved can be assured that the recorded data is accurate and unchangeable. Transparency is achieved as the blockchain ledger can be accessed and verified by authorized participants in the network, ensuring that every transaction is transparent and traceable.

The specific blockchain platform 108 used in this method is identified as the Polygon blockchain. Polygon is known for its scalability and efficiency in handling transactions, making it a suitable choice for recording these trade transaction details. While the Polygon blockchain is mentioned, the system 100 could alternatively employ other blockchain platform 108s depending on requirements such as transaction speed, cost, scalability, or specific features. Other blockchain platform 108s that could be used include Ethereum, for its widespread adoption and smart contract capabilities; Hyperledger Fabric, for its modularity and emphasis on privacy and permissioned networks; or Binance Smart Chain, known for its high performance and cross-chain compatibility.

The step 210 is pivotal in integrating blockchain technology into the agricultural trade transaction process. By recording critical transaction details like the IRC or CIC, event type, and timestamp on a blockchain, the system 100 ensures a high level of security, trust, and efficiency, which are fundamental in modern digital transactions.

Step 212 (generate a blockchain certificate): In accordance with an embodiment of the present invention, step 212 as shown in FIG. 3B, the processor 1024 is configured to generate a blockchain certificate for each event recorded on the blockchain platform 108. For each event recorded, the system 100 generates a blockchain certificate. This certificate signifies the blockchain's confirmation of either the acceptance of goods or payment, as indicated by the IRC or CIC. It also confirms the completion and immutability of the transactions within the agricultural trade process. Each certificate signifies the blockchain's confirmation of the acceptance of goods or payment as per the respective IRC or CIC. In accordance with an embodiment of the present invention, the processor 1024 is further configured to verify the legal form and competence of the parties to the contract based on the respective local jurisdictions before generating the IRC or CIC, ensuring that each digital smart contract is compliant with applicable international trade laws. Further the certificate confirms the completion and immutability of the respective transactions within the agricultural trade process.

The Step 212 in the computer-implemented method involves the generation of blockchain certificates for each event recorded on the blockchain platform 108. This step is a crucial part of ensuring the integrity and authenticity of the agricultural trade transactions. After the unique hashes (either IRC or CIC) are recorded onto the blockchain platform 108, the processor 1024 is configured to generate a blockchain certificate for each event. These certificates serve as a digital acknowledgment or receipt of the recorded events, providing an additional layer of validation.

Each certificate confirms the blockchain's acknowledgment of a specific event, whether it's the acceptance of goods (as indicated by the IRC) or the acceptance of payment (as indicated by the CIC). The certificates are a testament to the completion and immutability of the transactions. Once issued, they signify that the recorded event has been securely logged on the blockchain and cannot be altered, ensuring the trustworthiness of the transaction records. In accordance with an additional or alternative embodiment of the present invention, the memory unit 1022 may contain additional machine-readable instructions that, when executed by the processor 1024, enable the system 100 to automatically match buyers with sellers based on the availability of goods and requirements, thereby facilitating the formation of digital contracts within the agricultural trade process.

These blockchain certificates play a crucial role in the agricultural trade process. They provide parties involved (buyers, sellers, financiers, regulators, etc.) with verifiable proof that certain actions (like shipment of goods or payments) have been completed and recorded securely. This aspect is particularly important in digital transactions where physical paperwork is replaced by digital records, necessitating reliable methods to establish and maintain trust among parties.

The step 212 enhances the security and credibility of the agricultural trade process by generating blockchain certificates for each recorded event. These certificates are a key component in affirming the immutability and completion of transactions within the blockchain-based system, thereby fostering trust and reliability in digital agricultural trade transactions.

Step 214 (provide a verifiable and permanent record-keeping system): At step 214, the computer-implemented method 200 provide utilizing the blockchain platform 108 to provide a verifiable and permanent record-keeping system, wherein the immutability of records is achieved through the blockchain's inherent properties, thereby enhancing the security and authenticity of the agricultural trade documents. Finally, the system 100 utilizes the blockchain platform 108 to provide a verifiable and permanent record-keeping system. This system ensures the immutability of records through the inherent properties of the blockchain, thereby enhancing the security and authenticity of the agricultural trade documents.

At step 214 of the computer-implemented method, the system 100 utilizes the blockchain platform 108 to provide a verifiable and permanent record-keeping system. This step is critical in ensuring the security, authenticity, and reliability of the agricultural trade transaction process. The blockchain platform 108 is employed to maintain a permanent and immutable ledger of all transactions and related events. This use of blockchain technology means that once a transaction record, such as an IRC or CIC, along with its event type and timestamp, is entered into the blockchain, it cannot be altered or tampered with. The immutability of the blockchain ledger ensures that all transaction records are secure and authentic. It provides a trustworthy source of truth that can be referred to by all parties involved in the trade transaction. This characteristic is especially important in the agricultural trade sector, where the authenticity of documents like inspection reports and commercial invoices is crucial.

The blockchain system offers a transparent way to verify the authenticity and completion of transactions. All parties involved in the transaction can access the blockchain ledger to confirm the details and status of the transactions. This transparency is beneficial in building trust among all parties, reducing disputes, and streamlining the overall trade process. The step 214 represents the culmination of the transaction process in a blockchain environment, where the system 100 records transaction details. This step solidifies the blockchain platform's 108 role in enhancing the security, transparency, and efficiency of the agricultural trade documentation process.

### Working Example

To illustrate the best mode of operation for the present method involving a computer-implemented system for automating digital smart contracts in agricultural trade transactions on a blockchain platform 108, let's consider a hypothetical real-life example involving a small agri-business in the United States:

Example Scenario: Suppose there's a small business, “Green Farms,” located in California, United States, specializing in organic almonds. Green Farms wants to export a shipment of almonds to a buyer, “Healthy Snacks Ltd.,” based in the United Kingdom.

### Step 1: Transaction Document Initiation

Green Farms, using their seller device 106 (like a computer or tablet), uploads an inspection report confirming the quality and organic certification of the almonds. Healthy Snacks Ltd., through their buyer device 104, sends a signed delivery order and a commercial invoice to Green Farms, confirming the order and agreeing to the payment terms.

### Steps 2 and 3: Compiling and Watermarking Documents

The processor 1024 in Green Farms' computer system 102 compiles these documents (inspection report, delivery order, and commercial invoice). Each document is watermarked with a Unique Acceptance Code (UAC), which includes a Deal Transaction Number, Document Sequence and Type, and a GMT Timestamp. Example: INTJGELRM-01-DS -Jan. 1, 2024 13:49

### Step 4: Generating Unique Hashes

The system 100 generates a unique hash for each document. The inspection report receives an IRC, and the commercial invoice receives a CIC.

### Step 5: Recording on Blockchain

These hashes (IRC and CIC), along with the event type and document timestamp, are recorded on a blockchain platform 108 like Polygon. This step ensures the data is immutable and transparent.

### Step 6: Generating Blockchain Certificates

For each recorded event, a blockchain certificate is generated, signifying the blockchain's confirmation of the acceptance of goods and payment.

### Step 7: Verifiable Record-Keeping

The blockchain platform 108 provides a permanent, verifiable record-keeping system, enhancing the security and authenticity of the transaction documents.

### Real-Life Application:

In this scenario, Green Farms benefits from enhanced security and streamlined operations. The blockchain system ensures that all documents are authentic and tamper-proof.

Healthy Snacks Ltd. can verify the authenticity of the almonds' inspection report and can trust the transaction process. Both parties have access to a transparent record of the transaction, reducing the risk of disputes and building trust in the trade relationship. The blockchain certificates serve as proof of the transaction's completion, useful for both Green Farms and Healthy Snacks Ltd. for future reference, auditing, or in case of any legal requirements. The system's 100 ability to track and authenticate each step of the transaction provides Green Farms with an edge in international trade, ensuring compliance with international standards and reducing risks associated with cross-border transactions.

In summary, the best mode of operation of this method for a small agri-business like Green Farms involves using the system 100 to handle, secure, and authenticate all aspects of the trade transaction from document initiation and compilation to final blockchain recording and certificate generation. This not only streamlines the export process but also adds a layer of security and trust that is crucial in international trade, especially for small businesses navigating complex global markets.

Furthermore, the invention can be used to implement the blockchain mechanism to enable third-party institutions, such as financial entities, to authenticate trade documents. When trade documents (like bills of lading, commercial invoices, etc.) are verified on the platform, they are hashed (encrypted into a unique digital code). These hashes are then recorded on the blockchain. Financial institutions or other interested parties can then compare the hash of the documents presented to them by buyers or sellers with the hash recorded on the blockchain.

A match confirms the authenticity of the documents, ensuring they haven't been tampered with since being verified on the platform. This use case enhances trust in trade transactions by providing a tamper-proof, decentralized method for document verification, crucial in international trade where documentation authenticity is paramount. This system 100 could significantly reduce fraud and errors, streamlining the verification process for all parties involved.

For example, a bank involved in international trade financing. The bank needs to ensure the authenticity of documents like letters of credit, bills of lading, and invoices presented by clients for trade transactions. With this blockchain-based system, when a client submits these documents, the bank can instantly verify their authenticity by comparing the document hashes with those stored on the blockchain. This verification process ensures the documents haven't been altered since their initial validation, significantly reducing the risk of fraud and streamlining the due diligence process. This technology enables the bank to conduct faster, more secure trade finance operations, benefiting both the bank and its clients in international trade.

The system 100 may offer enhanced security and efficiency in trade finance operations. The bank can swiftly verify the legitimacy of collateral documents, reducing the risk of fraudulent activities. This streamlined process leads to quicker loan approvals, boosting customer satisfaction. Moreover, it allows the bank to maintain a transparent and auditable record of transactions, ensuring compliance with regulatory requirements. This innovation not only fortifies the bank's risk management strategy but also positions it as a forward-thinking financial institution in the digital age.

The present invention, a computer-implemented system for automating the generation and execution of digital smart contracts for agricultural trade transactions using blockchain technology, offers several advantages over prior art in the field of trade transaction processing and documentation. Here are some of the key benefits:

### Enhanced Security and Immutability:

The use of blockchain technology ensures that all transaction records are immutable. Once a transaction is recorded on the blockchain, it cannot be altered or tampered with, which significantly reduces the risk of fraud and error in comparison to traditional record-keeping systems.

### Increased Transparency and Trust:

Every transaction is transparent and traceable. All parties involved in the trade can access and verify transaction records on the blockchain, leading to increased trust among buyers, sellers, and other stakeholders.

### Streamlined Documentation Process:

The system 100 automates the compilation, watermarking, and hashing of trade documents, reducing the time and effort typically required in manual processing. This automation leads to more efficient trade transactions, especially beneficial for small and medium-sized enterprises (SMEs) that may lack extensive administrative resources.

### Reduced Risk of Disputes:

With each document and transaction step being clearly recorded and verifiable on the blockchain, there is a reduced likelihood of disputes over the terms of trade or the state of goods, as all information is transparent and immutable.

Compliance with International Trade Standards:

The system 100 is designed to ensure that each digital smart contract is compliant with applicable international trade laws. This feature is particularly important for businesses engaged in cross-border trade, as it helps navigate various legal and regulatory landscapes.

### Improved Accessibility and User Experience:

The user interfaces on buyer and seller devices 106 allow for easier verification and signing of documents, making the system 100 more accessible and user-friendly.

### Cost-Effectiveness:

By reducing the need for extensive paper documentation and manual processing, the system 100 can potentially lower the costs associated with trade transactions.

### Real-Time Processing and Verification:

The system 100 allows for real-time processing and verification of documents and transactions, enabling quicker trade execution and decision-making.

Therefore, compared to prior art, the present invention offers a more secure, transparent, efficient, and user-friendly approach to managing agricultural trade transactions, leveraging blockchain technology and advanced computing techniques to address many of the challenges and limitations associated with traditional methods of trade documentation and contract execution. This innovation is particularly significant in the context of global trade, where the complexity and scale of transactions demand robust, reliable, and efficient systems for ensuring the integrity and smooth functioning of trade processes.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It is implied that the techniques of the present disclosure might be implemented using a variety of technologies. For example, the methods described herein may be implemented by a series of computer executable instructions residing on a suitable computer readable medium. Suitable computer readable media may include volatile (e.g., RAM) and/or non-volatile (e.g., ROM, disk) memory, carrier waves and transmission media. Exemplary carrier waves may take the form of electrical, electromagnetic or optical signals conveying digital data steams along a local network or a publicly accessible network such as the Internet.

Further, the operations need not be performed in the disclosed order, although in some examples, an order may be preferred. Also, not all functions need to be performed to achieve the desired advantages of the disclosed system and method, and therefore not all functions are required.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

1. A system for blockchain-enabled documentation of trade transactions, the system comprising:
one or more buyer devices associated with respective buyers;
one or more seller devices, associated with respective sellers;
a computer system associated connected with the one or more buyer devices and the one or more seller devices, the computer system including:
a processor; and
a memory unit configured to store machine readable instructions that, when executed by the processor, cause the computer system to:
receive, transaction documents from the one or more buyer devices and the one or more seller devices;
compile a set of transaction documents for each agricultural trade transaction, wherein a transaction from the buyer device is in relation to an event type selected from acceptance of goods or payment by the buyer;
watermark each of the compiled documents with a Unique Acceptance Code (UAC);
generate a unique hash for each document watermarked with the UAC, wherein the hash is either an Inspection Report Code (IRC) or a Commercial Invoice Code (CIC) corresponding to the acceptance of goods or payment by the buyer respectively, which serves as a novel identifier for the said document;
record the generated IRC or CIC onto the blockchain platform, along with the event type and document timestamp, to ensure the immutability and transparency of the transaction data;
generate a blockchain certificate for each event recorded on the blockchain platform; and
utilize the blockchain platform to provide a verifiable and permanent record-keeping system, wherein the immutability of records is achieved through the blockchain's inherent properties, thereby enhancing the security and authenticity of the contracts of the agricultural trade.

2. The system as claimed in claim 1, wherein the set of transaction documents comprising at least one of:
an inspection report received from the seller device, confirming the condition of goods supplied by a seller; and
a signed delivery order or commercial invoice from the one or more buyer devices, each related to the event type selected from the acceptance of goods or payment by the buyer, respectively.

3. The system as claimed in claim 1, wherein the UAC includes:
a Deal Transaction Number uniquely identifying the trade transaction;
a Document Sequence and Type indicating the sequential order and category of the document within the transaction; and
a GMT Timestamp marking the exact date and time of document issuance.

4. The system as claimed in claim 1, wherein the unique hash is designated as:
the Inspection Report Code (IRC) for documents corresponding to the acceptance of goods; or
the Commercial Invoice Code (CIC) for documents corresponding to the acceptance of payment by the buyer; each hash serving as a novel identifier for the said document.

5. The system as claimed in claim 1, wherein each certificate:
signifies the blockchain's confirmation of the acceptance of goods or payment as per the respective IRC or CIC; and
confirms the completion and immutability of the respective transactions within the agricultural trade process.

6. The system as claimed in claim 1, wherein the blockchain is a Polygon blockchain.

7. The system as claimed in claim 1, wherein the one or more buyer devices further comprise a user interface configured to allow buyers to manually verify and sign the delivery order or commercial invoice digitally within the device before providing it to the system.

8. The system as claimed in claim 1, wherein the one or more seller devices include an imaging component configured to capture visual confirmation of the goods for inclusion in the inspection report, and which integrates with the system to facilitate automatic watermarking with the UAC.

9. The system as claimed in claim 1, further comprising a cryptographic module managed by the processor that encrypts the unique hash for each document to enhance security before recording on the blockchain platform.

10. The system as claimed in claim 1, wherein the processor is further configured to verify the legal form and competence of the parties to the contract based on the respective local jurisdictions before generating the IRC or CIC, ensuring that each digital smart contract is compliant with applicable international trade laws.

11. The system as claimed in claim 1, wherein the memory unit contains additional machine-readable instructions that, when executed by the processor, enable the system to automatically match buyers with sellers based on the availability of goods and requirements, thereby facilitating the formation of digital contracts within the agricultural trade process.

12. A computer-implemented method for blockchain-enabled documentation of trade transactions, the method comprising steps of:
receiving, transaction documents from one or more buyers and one or more sellers;
compiling a set of transaction documents for each agricultural trade transaction, wherein a transaction from the buyer device is in relation to an event type selected from acceptance of goods or payment by the buyer;
watermarking each of the compiled documents with a Unique Acceptance Code (UAC);
generating a unique hash for each document watermarked with the UAC, wherein the hash is either an Inspection Report Code (IRC) or a Commercial Invoice Code (CIC) corresponding to the acceptance of goods or payment by the buyer respectively, which serves as a novel identifier for the said document;
recording the generated IRC or CIC onto the blockchain, along with the event type and document timestamp, to ensure the immutability and transparency of the transaction data;
generating a blockchain certificate for each event recorded on the blockchain platform;
utilizing the blockchain platform to provide a verifiable and permanent record-keeping system, wherein the immutability of records is achieved through the blockchain's inherent properties, thereby enhancing the security and authenticity of the agricultural trade documents.

13. The method as claimed in claim 12, wherein the set of documents comprising at least:
an inspection report confirming the condition of goods supplied by a seller; and
a signed delivery order or commercial invoice, each related to the acceptance of goods or payment by a buyer, respectively.

14. The method as claimed in claim 12, wherein the UAC includes:
a Deal Transaction Number uniquely identifying the trade transaction;
a Document Sequence and Type indicating the sequential order and category of the document within the transaction; and
a GMT Timestamp marking the exact date and time of document issuance.

15. The method as claimed in claim 12, wherein the unique hash is designated as:
an Inspection Report Code (IRC) for documents corresponding to the acceptance of goods; or
a Commercial Invoice Code (CIC) for documents corresponding to the acceptance of payment by the buyer; each hash serving as a novel identifier for the said document.

16. The method as claimed in claim 12, wherein each certificate:
signifies the blockchain's confirmation of the acceptance of goods or payment as per the respective IRC or CIC; and
confirms the completion and immutability of the respective transactions within the agricultural trade process.

17. The method as claimed in claim 12, further comprising step of allowing buyers to manually verify and sign the delivery order or commercial invoice digitally within the device before providing it to the system.

18. The method as claimed in claim 12, comprising step of capturing visual confirmation of the goods for inclusion in the inspection report, and which integrates with the system to facilitate automatic watermarking with the UAC.

19. The method as claimed in claim 12, further comprising step of encrypting the unique hash for each document to enhance security before recording on the blockchain platform.

20. The method as claimed in claim 12, comprising step of verifying the legal form and competence of the parties to the contract based on the respective local jurisdictions before generating the IRC or CIC, ensuring that each digital smart contract is compliant with applicable international trade laws.
